(19) United States
(12) Patent Application Publication
(10) Pub. No.: US 2026/0195646 A1
(43) Pub. Date: Jul. 9, 2026

(54) DISTRIBUTED COMPUTING SYSTEM AND DISTRIBUTED COMPUTING METHOD

(71) Applicant: GIGA-BYTE TECHNOLOGY CO.,LTD., New Taipei City (TW)

(72) Inventors: Quang Tuyen Le, New Taipei City (TW); Tse-Hsien Liao, New Taipei City (TW); Che Hao Liu, New Taipei City (TW); Wei-Hao Huang, New Taipei City (TW); Kai Hua Chang, New Taipei City (TW); Chia-Jui Wang, New Taipei City (TW); Tai-Yi Lin, New Taipei City (TW); Kuo-Ting Chan, New Taipei City (TW); Ta Wei Tseng, New Taipei City (TW); Chia Ying Wu, New Taipei City (TW); Hang Yee Li, New Taipei City (TW)

(73) Assignee: GIGA-BYTE TECHNOLOGY CO.,LTD., New Taipei City (TW)

(21) Appl. No.: 19/287,827

(22) Filed: Aug. 1, 2025

Related U.S. Application Data
(60) Provisional application No. 63/741,417, filed on Jan. 3, 2025.

(30) Foreign Application Priority Data
Apr. 10, 2025 (TW) 114113508

(51) Int. Cl. G06N 20/00

(52) U.S. Cl. CPC G06N 20/00

(57) ABSTRACT

A distributed computing system and a distributed computing method are provided. The distributed computing system includes a first computing device and a second computing device. The second computing device is connected to the first computing device through a cable. The distributed computing module calculates a buffer size required by a model to determine a memory usage strategy. The distributed computing module splits the model to generate multiple sub-models. The distributed computing module allocates the sub-models to multiple display memories of the first computing device and the second computing device according to the memory usage strategy, and selectively uses at least one of multiple dynamic random-access memories of the first computing device and the second computing device to perform distributed training of the model.

### CROSS-REFERENCE TO RELATED APPLICATION

This application claims the priority benefit of U.S. Provisional Application No. 63/741,417, filed on Jan. 3, 2025 and Taiwan Application No. 114113508, filed on Apr. 10, 2025. The entirety of each of the above-mentioned patent applications is hereby incorporated by reference herein and made a part of this specification.

### BACKGROUND

### Technical Field

The disclosure relates to a system, and more particularly to a distributed computing system and a distributed computing method.

### Description of Related Art

In existing large model training, a large number of display memories (video random-access memories, VRAMs) is often required to train a model. However, insufficient computing resources and buffers are common issues currently. Therefore, how to integrate memory computing resources of multiple computing devices and optimize training efficiency is an important topic in the art currently.

### SUMMARY

The disclosure provides a distributed computing system and a distributed computing method, which can efficiently train a large model through multiple computing devices.

A distributed computing system of the disclosure includes a first computing device, a second computing device, and a distributed computing module. The second computing device is connected to the first computing device through a cable. The distributed computing module is coupled to the first computing device and the second computing device, and is disposed in the first computing device or the second computing device. The distributed computing module calculates a buffer size required by a model to determine a memory usage strategy. The distributed computing module splits the model to generate multiple sub-models. The distributed computing module allocates the sub-models to multiple display memories of the first computing device and the second computing device according to the memory usage strategy, and selectively uses at least one of multiple dynamic random-access memories of the first computing device and the second computing device to perform distributed training of the model.

A distributed computing method of the disclosure is applicable to a distributed computing system. The distributed computing system includes a first computing device and a second computing device. The second computing device is connected to the first computing device through a cable. The distributed computing method includes the following steps. A buffer size required by a model is calculated to determine a memory usage strategy. The model is split to generate multiple sub-models. The sub-models are allocated to multiple display memories of the first computing device and the second computing device according to the memory usage strategy, and at least one of multiple dynamic random-access memories of the first computing device and the second computing device is selectively used to perform distributed training of the model.

Based on the above, the distributed computing system and the distributed computing method of the disclosure may perform distributed training of the large model through the display memories of the first computing device and the second computing device.

In order for the features and advantages of the disclosure to be more comprehensible, the following specific embodiments are described in detail in conjunction with the drawings.

### BRIEF DESCRIPTION OF THE DRAWINGS

FIG. 1 is a schematic diagram of a distributed computing system according to an embodiment of the disclosure.

FIG. 2 is a schematic diagram of a software architecture according to an embodiment of the disclosure.

FIG. 3 is a flowchart of a distributed computing method according to an embodiment of the disclosure.

FIG. 4 is a flowchart of a distributed computing method according to another embodiment of the disclosure.

FIG. 5 is a schematic diagram of model splitting and allocation according to an embodiment of the disclosure.

FIG. 6 is a schematic diagram of a pipeline for forward transmission according to an embodiment of the disclosure.

FIG. 7 is a schematic diagram of micro-batch data processing according to an embodiment of the disclosure.

### DESCRIPTION OF THE EMBODIMENTS

In order for the content of the disclosure to be more comprehensible, the following specific embodiments are given as examples according to which the disclosure can indeed be implemented. In addition, wherever possible, elements/components/steps using the same reference numerals in the drawings and the embodiments represent the same or similar parts.

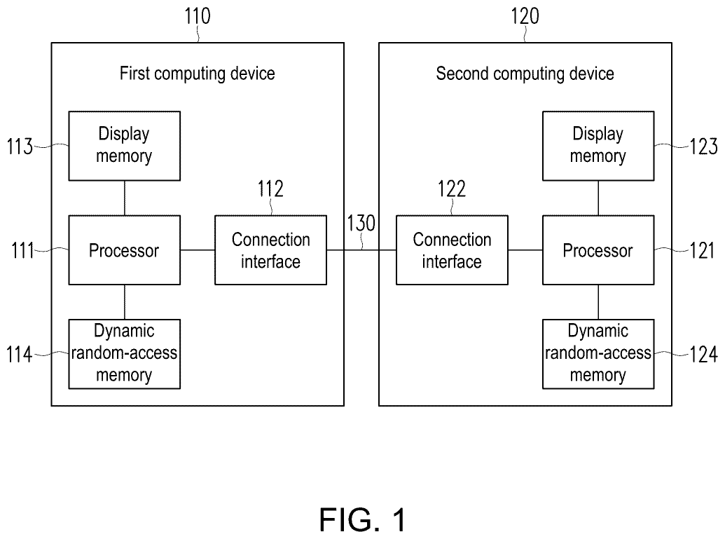

FIG. 1 is a schematic diagram of a distributed computing system according to an embodiment of the disclosure. Referring to FIG. 1, a distributed computing system 100 includes a first computing device 110 and a second computing device 120. The first computing device includes a processor 111, a connection interface 112, a display memory (video random-access memory, VRAM) 113, and a dynamic random-access memory (DRAM) 114. The processor 111 is coupled to the connection interface 112, the display memory 113, and the dynamic random-access memory 114. The second computing device 120 includes a processor 121, a connection interface 122, a display memory 123, and a dynamic random-access memory 124. The processor 121 is coupled to the connection interface 122, the display memory 123, and the dynamic random-access memory 124.

It should be noted that the number of the display memories 113 and 123 and the dynamic random-access memories 114 and 124 of the disclosure may be one or more and is not limited to that shown in FIG. 1. In addition, the first computing device 110 and the second computing device 120 may further include other functional devices, circuits, and other types of memories for model training or model computation and are not limited to those shown in FIG. 1. In an embodiment, the first computing device 110 and the second computing device 120 may further respectively include a non-volatile memory express solid-state drive (NVMe SSD) and be allocated for model training or model computation. In addition, in an embodiment, the distributed computing system 100 may further include multiple computing devices, which are connected in series through multiple cables, and is not limited to that shown in FIG. 1.

In the embodiment, the first computing device 110 and the second computing device 120 may respectively be computer hosts, and the connection interface 112 of the first computing device 110 is connected to the connection interface 122 of the second computing device 120 through a cable 130. In the embodiment, the processors 111 and 121 may respectively be a central processing unit (CPU). In the embodiment, the cable 130 may be a Thunderbolt cable (for example, Thunderbolt Gen 4, Thunderbolt Gen 5, or higher specifications).

In the embodiment, the first computing device 110 and the second computing device 120 may implement data transmission and communication through the cable 130 to implement model training or model computation. In the embodiment, the first computing device 110 and the second computing device 120 may be installed with a secure shell (SSH) program (for example, openssh-server package or sshpass package), so that the first computing device 110 and the second computing device 120 may be respectively allocated with a static IP address to implement stable communication. Furthermore, the first computing device 110 and the second computing device 120 may synchronize training data and assign computing tasks based on the SSH program.

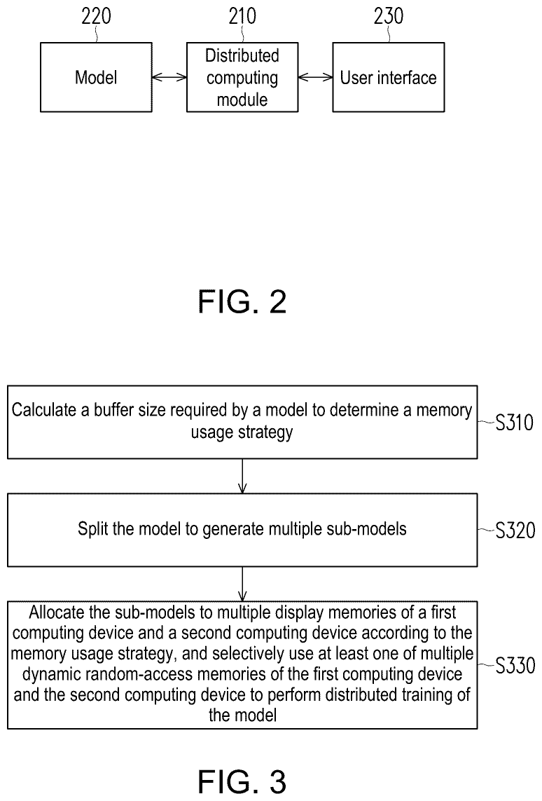

FIG. 2 is a schematic diagram of a software architecture according to an embodiment of the disclosure. Referring to FIG. 1 and FIG. 2, in the embodiment, one of the first computing device 110 and the second computing device 120 may store a distributed computing module 210, a model 220, and a user interface 230. In the embodiment, the model 220 may be a large model, such as a large language model (LLM) or a large multimodal model (LMM). In the embodiment, one of the processor 111 and the processor 121 may execute the distributed computing module 210 to perform distributed training of the model 220. Furthermore, one of the processor 111 and the processor 121 may execute the user interface 230 to provide related functions through the user interface 230.

Specifically, the user interface 230 may be, for example, configured to display multiple selection fields. The selection fields are, for example, used for selecting models, data set settings (data sets to be used for training), fine-tuning strategies and settings for model training, training settings, learning rate settings, setting batch size (affecting usage amount of display memory), training cycle number settings, hardware settings, memory usage strategies (that is, memory unloading strategies), related advanced settings, etc., and the disclosure is not limited thereto. In the embodiment, the user interface 230 may also visually present related model training content to a user, thereby implementing convenient related model training operations.

FIG. 3 is a flowchart of a distributed computing method according to an embodiment of the disclosure. Referring to FIG. 1 to FIG. 3, the distributed computing system 100 may execute steps S310 to S330 below. In step S310, the distributed computing module 210 may calculate a buffer size required by the model 220 to determine the memory usage strategy. In step S320, the distributed computing module 210 may split the model 220 to generate multiple sub-models. In step S330, the distributed computing module 210 may allocate the sub-models to multiple display memories of the first computing device 110 and the second computing device 120 according to the memory usage strategy, and selectively use at least one of multiple dynamic random-access memories of the first computing device 110 and the second computing device 120 to perform distributed training of the model 220.

In the embodiment, when the distributed computing module 210 judges that the display memories 113 and 123 of the first computing device 110 and the second computing device 120 are sufficient to accommodate the buffer size required by the model 220, the memory usage strategy is to use only at least one of the display memories 113 and 123 of the first computing device 110 and the second computing device 120 to train the sub-models.

In the embodiment, when the distributed computing module 210 judges that the display memories 113 and 123 of the first computing device 110 and the second computing device 120 cannot accommodate the buffer size required by the model 220, the memory usage strategy includes allocating at least part of optimizer state data of the sub-models to at least one of the dynamic random-access memories 114 and 124 of the first computing device 110 and the second computing device 120. The optimizer state data may include, for example, learning rate, gradient, checkpoint, and/or training log, etc.

In the embodiment, when the distributed computing module 210 judges that the display memories 113 and 123 of the first computing device 110 and the second computing device 120 cannot accommodate the buffer size required by the model 220, the memory usage strategy includes allocating at least part of the optimizer state data of the sub-models and at least part of multiple model parameters to at least one of the dynamic random-access memories 114 and 124 of the first computing device 110 and the second computing device 120. The model parameters include, for example, weights or other learnable variables that need to be optimized during the model training process.

In the embodiment, the display memories 113 and 123 of the first computing device 110 and the second computing device 120 may be used for high-speed calculation, and the dynamic random-access memories 114 and 124 of the first computing device 110 and the second computing device 120 may be configured to store related data required or generated during the model training process. Therefore, the distributed computing system 100 of the embodiment may dynamically adjust a usage state of a memory according to the memory usage strategy of different models, thereby effectively improving overall resource utilization and model training efficiency.

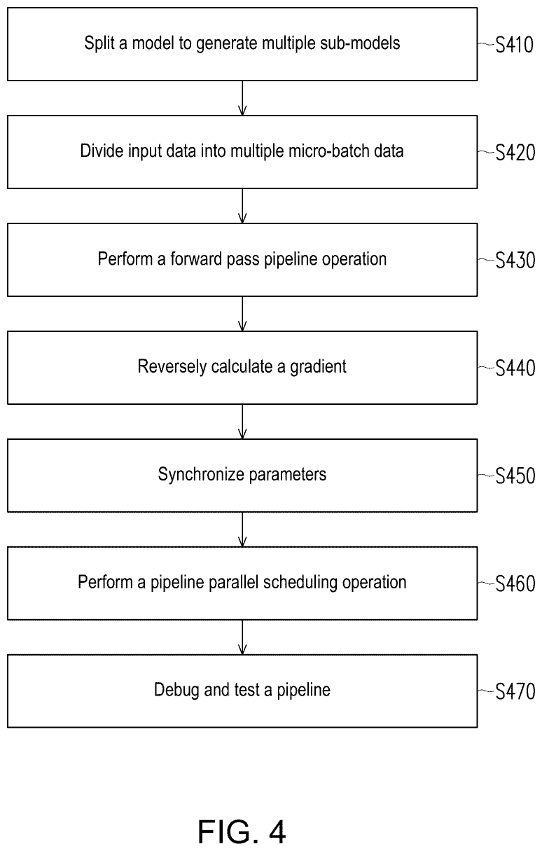

FIG. 4 is a flowchart of a distributed computing method according to another embodiment of the disclosure. FIG. 4 is a further detailed implementation flow of the embodiment of FIG. 3. Referring to FIG. 1, FIG. 2, and FIG. 4, in the embodiment, the distributed computing system 100 may execute steps S410 to S470 below. In step S410, the distributed computing module 210 may split the model 220 to generate the sub-models. The distributed computing module 210 may allocate the sub-models to the memories of the first computing device 110 and the second computing device 120.

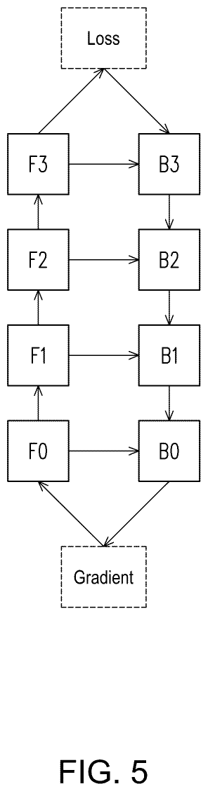

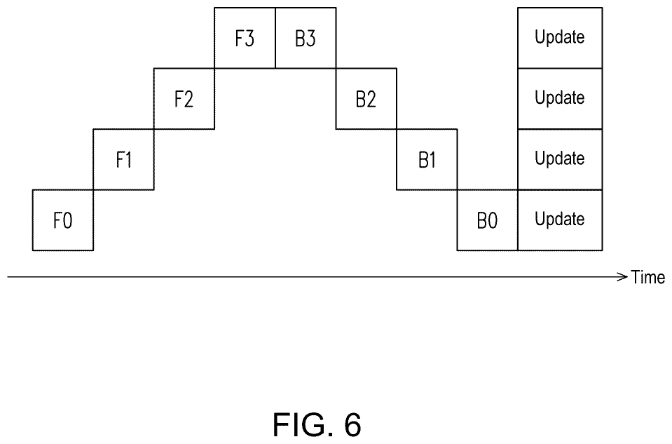

For example, please also refer to FIG. 5 and FIG. 6. FIG. 5 is a schematic diagram of model splitting and allocation according to an embodiment of the disclosure. FIG. 6 is a schematic diagram of a pipeline for forward transmission according to an embodiment of the disclosure. As shown in FIG. 5 and FIG. 6, the model 220 may be divided into multiple sub-models F0 to F3. The sub-models F0 to F3 may be allocated to different display memories of the first computing device 110 and the second computing device 120 for execution. The sub-models F0 to F3 may sequentially input a computed loss function into the next sub-model for summarization. Output data B0 to B3 (for example, gradients) sequentially calculated by the sub-models F0 to F3 may be summarized and input back into the sub-models F0 to F3 to serve as a basis for updating the model parameters in the next step.

In step S420, the distributed computing module 210 may divide input data into multiple micro-batch data, and simultaneously process the micro-batch data through different sub-models parallelly processed by the pipeline, wherein the number of the micro-batch data matches the capacity of the parallel processing.

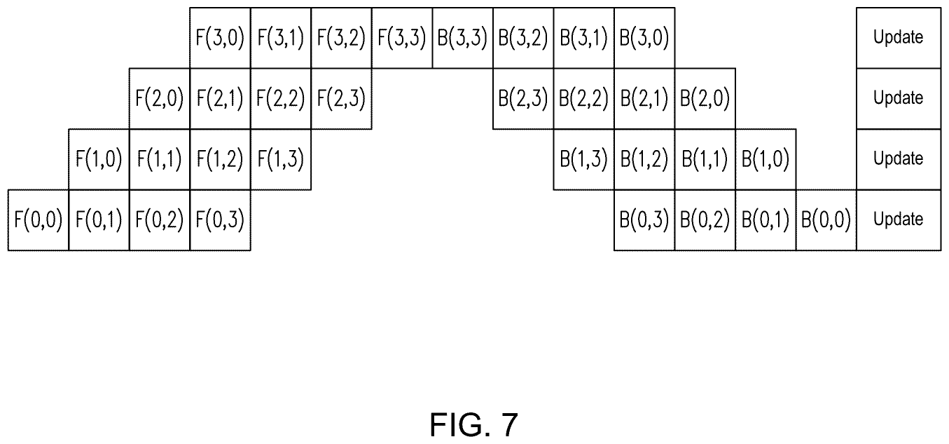

For example, please also refer to FIG. 7. FIG. 7 is a schematic diagram of micro-batch data processing according to an embodiment of the disclosure. The input data may be split into multiple smaller micro-batch data to be sequentially input into sub-models F(0,0) to F(0,3). In this regard, the sub-model F(0,0) may first compute one micro-batch data to output data to the sub-model F(1,0) at the next time point. At the same time, during the process of the sub-model F(1,0) computing, the sub-model F(0,1) may compute the next micro-batch data. Similarly, the sub-models F(0,0) to F(3,3) may be perform parallel computation to generate output data B(0,0) to B(3,3).

In step S430, the distributed computing module 210 may perform a forward pass pipeline operation to sequentially process the micro-batch data. In step S440, the distributed computing module 210 may reversely calculate a gradient. In step S450, the distributed computing module 210 may synchronize parameters. The distributed computing module 210 may perform data transmission between the first computing device 110 and the second computing device 120 through a distributed communication library (for example, PyTorch, TensorFlow) to reduce latency and optimize data transmission. Furthermore, the distributed computing module 210 may use mechanisms such as synchronization barriers or explicit waiting to ensure that during model training or model computation, sub-models executed by all memories can be correctly aligned during forward and backward passes in parallel processing.

In step S460, the distributed computing module 210 may perform a pipeline parallel scheduling operation. In the embodiment, the distributed computing module 210 trains the sub-models using the display memories 113 and 123 of the first computing device 110 and the second computing device 120 through micro-batch interleaving and micro-batch overlapping. Furthermore, the distributed computing module 210 may adjust memory usage amounts of the first computing device 110 and the second computing device 120 through a gradient checkpointing operation. In this regard, the distributed computing module 210 may adjust model partitioning through balanced calculation to reduce idle time of a computing device, and may reduce the memory usage amount during the forward pass computing period using gradient checkpointing.

In step S470, the distributed computing module 210 may debug and test the pipeline. In the embodiment, the distributed computing module 210 may verify data flow to ensure that an output of a stage is correctly received as an input by the next stage. In the embodiment, the distributed computing module 210 may monitor performance to identify any computing bottleneck through measuring latency and throughput. The distributed computing module 210 may analyze equipment utilization using an analytical tool and perform corresponding optimization. The distributed computing module 210 may test the gradient to verify the correctness of the gradient during a backpropagation process, thereby ensuring correct model training. In addition, when a computing device is added to the distributed computing system 100, the distributed computing module 210 may further reallocate the sub-models to balance the workload of the additional equipment. Accordingly, the distributed computing method of the embodiment may train the large model by distributed computation through the computing devices.

In summary, the distributed computing system and the distributed computing method of the disclosure may train the large model through combining the memory resources of the computing devices. Furthermore, the distributed computing system and the distributed computing method of the disclosure may generate the corresponding memory usage strategy according to different model types, so that the memory resources may be efficiently used to train the large model.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A distributed computing system, comprising:
a first computing device;
a second computing device, connected to the first computing device through a cable; and
a distributed computing module, coupled to the first computing device and the second computing device, and disposed in the first computing device or the second computing device,
wherein the distributed computing module calculates a buffer size required by a model to determine a memory usage strategy, and the distributed computing module splits the model to generate a plurality of sub-models,
wherein the distributed computing module allocates the sub-models to a plurality of display memories of the first computing device and the second computing device according to the memory usage strategy, and selectively uses at least one of a plurality of dynamic random-access memories of the first computing device and the second computing device to perform distributed training of the model.

2. The distributed computing system according to claim 1, wherein the distributed computing module divides input data into a plurality of micro-batch data, and simultaneously processes the micro-batch data through different sub-models.

3. The distributed computing system according to claim 1, wherein the distributed computing module performs data transmission between the first computing device and the second computing device through a distributed communication library.

4. The distributed computing system according to claim 1, wherein the distributed computing module trains the sub-models through the display memories of the first computing device and the second computing device by micro-batch interleaving and micro-batch overlapping.

5. The distributed computing system according to claim 1, wherein the distributed computing module adjusts memory usage amounts of the first computing device and the second computing device through a gradient checkpointing operation.

6. The distributed computing system according to claim 1, wherein the model is a large language model or a large multimodal model.

7. The distributed computing system according to claim 1, wherein when the distributed computing module judges that the display memories of the first computing device and the second computing device are sufficient to accommodate the buffer size required by the model, the memory usage strategy is to use only at least one of the display memories of the first computing device and the second computing device to train the sub-models.

8. The distributed computing system according to claim 1, wherein when the distributed computing module judges that the display memories of the first computing device and the second computing device cannot accommodate the buffer size required by the model, the memory usage strategy comprises allocating at least part of a plurality of optimizer state data of the sub-models to at least one of the dynamic random-access memories of the first computing device and the second computing device.

9. The distributed computing system according to claim 1, wherein when the distributed computing module judges that the display memories of the first computing device and the second computing device cannot accommodate the buffer size required by the model, the memory usage strategy comprises allocating at least part of a plurality of optimizer state data of the sub-models and at least part of a plurality of model parameters to at least one of the dynamic random-access memories of the first computing device and the second computing device.

10. The distributed computing system according to claim 1, wherein the cable is a Thunderbolt cable.

11. A distributed computing method, applicable to a distributed computing system, wherein the distributed computing system comprises a first computing device and a second computing device, and the second computing device is connected to the first computing device through a cable, the distributed computing method comprising:
calculating a buffer size required by a model to determine a memory usage strategy;
splitting the model to generate a plurality of sub-models; and
allocating the sub-models to a plurality of display memories of the first computing device and the second computing device according to the memory usage strategy, and selectively using at least one of a plurality of dynamic random-access memories of the first computing device and the second computing device to perform distributed training of the model.

12. The distributed computing method according to claim 11, further comprising:
dividing input data into a plurality of micro-batch data, and simultaneously processing the micro-batch data through different sub-models.

13. The distributed computing method according to claim 11, further comprising:
performing data transmission between the first computing device and the second computing device through a distributed communication library.

14. The distributed computing method according to claim 11, further comprising:
training the sub-models through the display memories of the first computing device and the second computing device by micro-batch interleaving and micro-batch overlapping.

15. The distributed computing method according to claim 11, further comprising:
adjusting memory usage amounts of the first computing device and the second computing device through a gradient checkpointing operation.

16. The distributed computing method according to claim 11, wherein the model is a large language model or a large multimodal model.

17. The distributed computing method according to claim 11, wherein when the display memories of the first computing device and the second computing device are sufficient to accommodate the buffer size required by the model, the memory usage strategy is to use only at least one of the display memories of the first computing device and the second computing device to train the sub-models.

18. The distributed computing method according to claim 11, wherein when the display memories of the first computing device and the second computing device cannot accommodate the buffer size required by the model, the memory usage strategy comprises allocating at least part of a plurality of optimizer state data of the sub-models to at least one of the dynamic random-access memories of the first computing device and the second computing device.

19. The distributed computing method according to claim 11, wherein when the display memories of the first computing device and the second computing device cannot accommodate the buffer size required by the model, the memory usage strategy comprises allocating at least part of a plurality of optimizer state data of the sub-models and at least part of a plurality of model parameters to at least one of the dynamic random-access memories of the first computing device and the second computing device.

20. The distributed computing method according to claim 11, wherein the cable is a Thunderbolt cable.
